(19) United States
(12) Patent Application Publication
(10) Pub. No.: US 2007/0299891 A1
(43) Pub. Date: Dec. 27, 2007

(54) Data back-up utility

(75) Inventors: John Jopp, Kannapolis, NC (US); Felix Ammay, Kings Mountain, NC (US); Aaron D. Harrell, Charlotte, NC (US)

Correspondence Address: MERCHANT & GOULD BELLSOUTH CORPORATION, P.O. BOX 2903, MINNEAPOLIS, MN, 55402, US

(73) Assignee: BellSouth Intellectual Property Corporation

(21) Appl. No.: 11/474,711

(22) Filed: Jun. 26, 2006

(51) Int. Cl. G06F 17/30

(52) U.S. Cl. 707/204

(57) ABSTRACT

A back-up utility for data based on user selectable configuration(s) is provided. A user interface enables users to define or select from default parameters for source and destination paths, frequency of back-ups, filters to be applied, and the like. Formatting, naming convention, and the like, of the source data may be modified in creating the back-up copy. Other considerations such as user credentials and permission levels may also be used to define or restrict back-up configuration parameters.

### TECHNICAL FIELD

Embodiments are related to backing-up data in a computing environment. More particularly, the disclosed subject matter is related to computer-implemented methods, configurations, systems, and computer program products for configuring and deploying a data back-up application for ensuring safety of data based on user selectable configuration(s).

### BACKGROUND

Computing devices operate by consuming internally or externally stored data. Because computing devices and storage media are prone to malfunction, various data back-up systems are utilized. In an enterprise environment, where multiple users can access, consume, and modify shared data, ensuring security of the data is especially critical. Loss of data due to a computer crash, network malfunction, and the like, may result in loss of productivity.

Some available data back-up systems may create back-up copies of entire hard drives. Copying large amounts of data is not only time consuming, but it can also tie up valuable system resources. Furthermore, each user in an enterprise system may have a different data usage profile. For example, one user may go through large amounts of data and modify files during a particular time of day, while another user may modify a small amount of data. A one-size-fits-all type back-up system may not necessarily address the needs of such users with different profiles.

### SUMMARY

Consistent with embodiments described herein, systems and methods are disclosed for providing a data back-up utility in computing systems. Key features or essential features of the claimed subject matter are not necessarily identified in this summary portion.

Embodiments are directed to determining a source and a destination for data to be backed up applying a configuration parameter determined by a user. The configuration parameter may include a frequency of the back-up, a filter to be applied for selecting data, and the like. The configuration parameter(s) may be user selected among options provided in a configuration user interface or entered by the user. Formatting and/or naming of data in the back-up copy may be modified from the original data to preserve system resources or to identify the original data from the back-up copy.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

FIG. 1 is a block diagram of an example computing operating environment;

FIG. 2 illustrates a system where example embodiments may be implemented;

FIG. 3 illustrates an example data back-up utility architecture according to embodiments;

FIG. 4 illustrates a screenshot of an example data back-up application configuration user interface (UI);

FIG. 5 illustrates a screenshot of an example data back-up application status UI; and

FIG. 6 illustrates a logic flow diagram for a process of backing-up data based on user selectable configuration(s) according to one embodiment.

### DETAILED DESCRIPTION

As briefly described above, a data back-up utility may be provided performing data back-up based on user selectable configurations. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

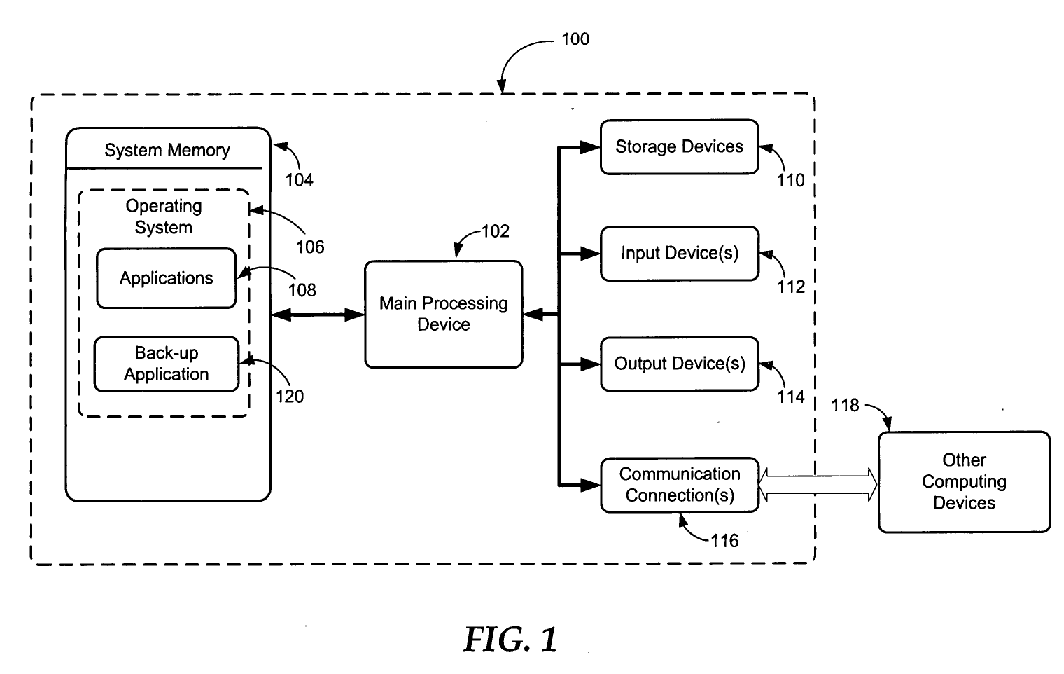

Referring now to the drawings, aspects and an exemplary operating environment will be described. FIG. 1 and the following discussion are intended to provide a brief, general description of a suitable computing environment in which the invention may be implemented. While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and the like. Embodiments may also be practiced in distributed computing environments where tasks are performed by remote processing devices that are linked through a communications network. In a distributed computing environment, program modules may be located in both local and remote memory storage devices.

Embodiments may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

With reference to FIG. 1, one example system for implementing the embodiments includes a computing device, such as computing device 100. Computing device 100 may typically include a main processing device 102 and system memory 104. The system memory 104 may be volatile (such as RAM), non-volatile (such as ROM, flash memory, etc.) or some combination of the two. System memory 104 typically provides an environment for an operating system 106 to be executed for controlling the operation of computing device 100 and execution of other programs (applications). Software applications 108 such as program modules and back-up application 120 are examples of programs or program modules that may be executed under the control of operating system 106 in system memory 104. Additional operating systems or programs may also be executed within system memory 104 outside the control of operating system 106. Back-up application 120 enables a user to back up data from specified sources to specified destinations such as internal or external hard drives, virtual drives, portable storage devices, and the like, based on user selectable configurations such as timing of the back-up process, filters to be applied, and the like.

Back-up application 120 may be an integrated part of a file management application or a separate application. Back-up application 120 may communicate with other applications running on computing device 100 or on other devices. Furthermore, back-up application 120 may be executed in an operating system other than operating system 106.

The computing device 100 may have additional features or functionality. For example, the computing device 100 may also include data storage devices 110 (removable and/or non-removable) such as, for example, magnetic disks, optical disks, or tape. Computer storage media may include volatile and nonvolatile, removable and non-removable media implemented in any method or technology for storage of information, such as computer readable instructions, data structures, program modules, or other data. System memory 104 and storage devices 110 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100.

Computing device 100 may also include input device(s) 112 such as a keyboard, a mouse, a pen, a voice input device, a touch input device, etc. Furthermore, output device(s) 114 such as a display, a speaker, a printer, etc. may also be included. These devices are well known in the art.

Communication connections 116 may be included in computing device 100 to allow the device to communicate with other computing devices 118, such as over a network in a distributed computing environment, for example, an intranet or the Internet. Communication connection 116 exemplifies various communication media. Communication media may be embodied by computer readable instructions, data structures, program modules, or other data in a modulated data signal, such as a carrier wave or other transport mechanism, and include any information delivery media.

By way of example, and not limitation, communication media may include wired media such as a wired network or direct-wired connection, and wireless media such as acoustic, RF, infrared and other wireless media. The term computer readable media as used herein refers to both storage media and communication media.

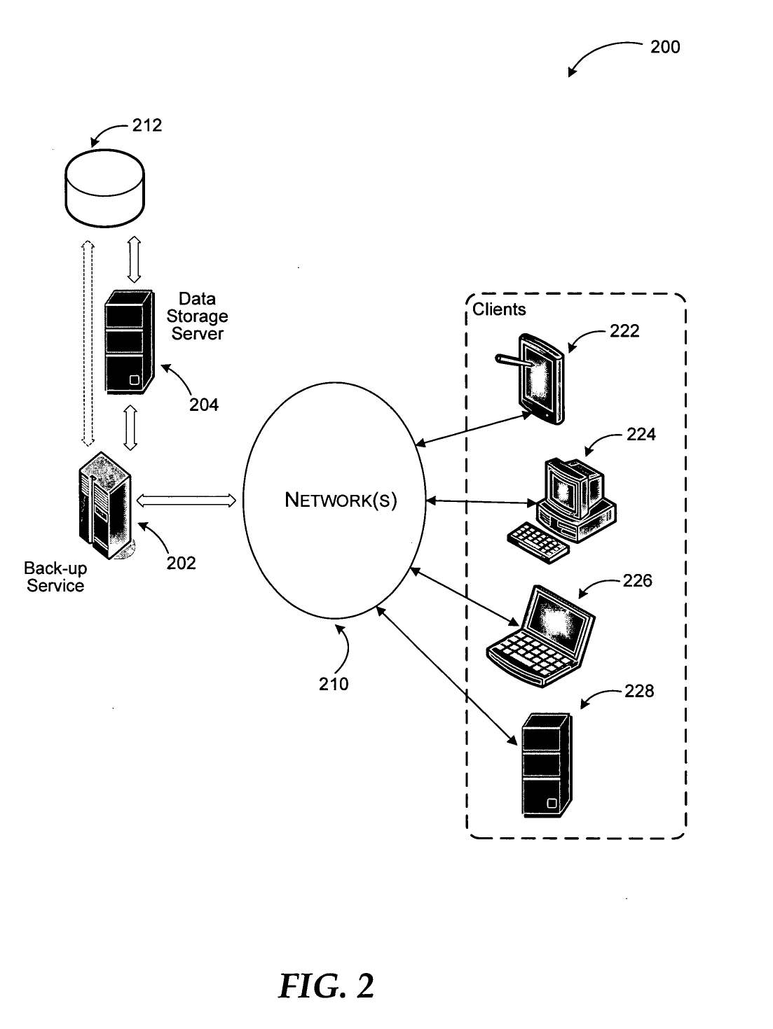

Referring to FIG. 2, a system 200 where example embodiments may be implemented, is illustrated. System 200 may comprise any topology of servers, clients, Internet service providers, and communication media. Also, system 200 may have a static or dynamic topology. The term “client” may refer to a client application or a client device employed by a user to perform business logic operations. Back-up service 202 may be one or more programs or a server machine executing programs associated with the server tasks. Both clients and application servers may be embodied as single device (or program) or a number of devices (programs). Similarly, data sources may include one or more data stores, input devices, and the like.

The back-up application 120 may be run centrally on back-up service 202 or in a distributed manner over several servers and/or client devices. Back-up service 202 may include implementation of a number of data management systems such as data storage, data refreshing, data maintenance scheduling, and the like, in addition to back-up application 120. A number of other applications may also be configured, deployed, and shared in system 200. In addition, the back-up application 120 may also be run in one or more client devices and information exchanged over network(s) 210.

Data store 212 is an example of a number of data stores that may be utilized to store back-up copies of the data. Data store 212 may be managed by data storage server 204 or directly accessed by back-up service 202 or any one of the clients.

Users may interact with back-up service 202 running the back-up application 120 from client devices 222, 224, 226, and 228 over network(s) 210. In one embodiment, portions or all of the back-up application 120 may reside on any one of the client devices 222, 224, 226, and 228. In such an embodiment, data may be stored in data store 212 without an involvement of back-up service 202.

According to some embodiments, users may be provided one or more user interfaces (“UIs”) to select and define configurations associated with backing up the data such as actions of back-up service 202, data store 212, and the like. User selectable configuration of the back-up service 202 may enable different users to configure the process for increased efficiency.

Network(s) 210 may include a secure network such as an enterprise network, or an unsecure network such as a wireless open network. Network(s) 210 provide communication between the nodes described above. By way of example, and not limitation, network(s) 210 may include wired media such as a wired network or direct-wired connection, and wireless media such as acoustic, RF, infrared and other wireless media.

Many other configurations of computing devices, applications, and data storage may be employed to implement a back-up system with user selectable configurations.

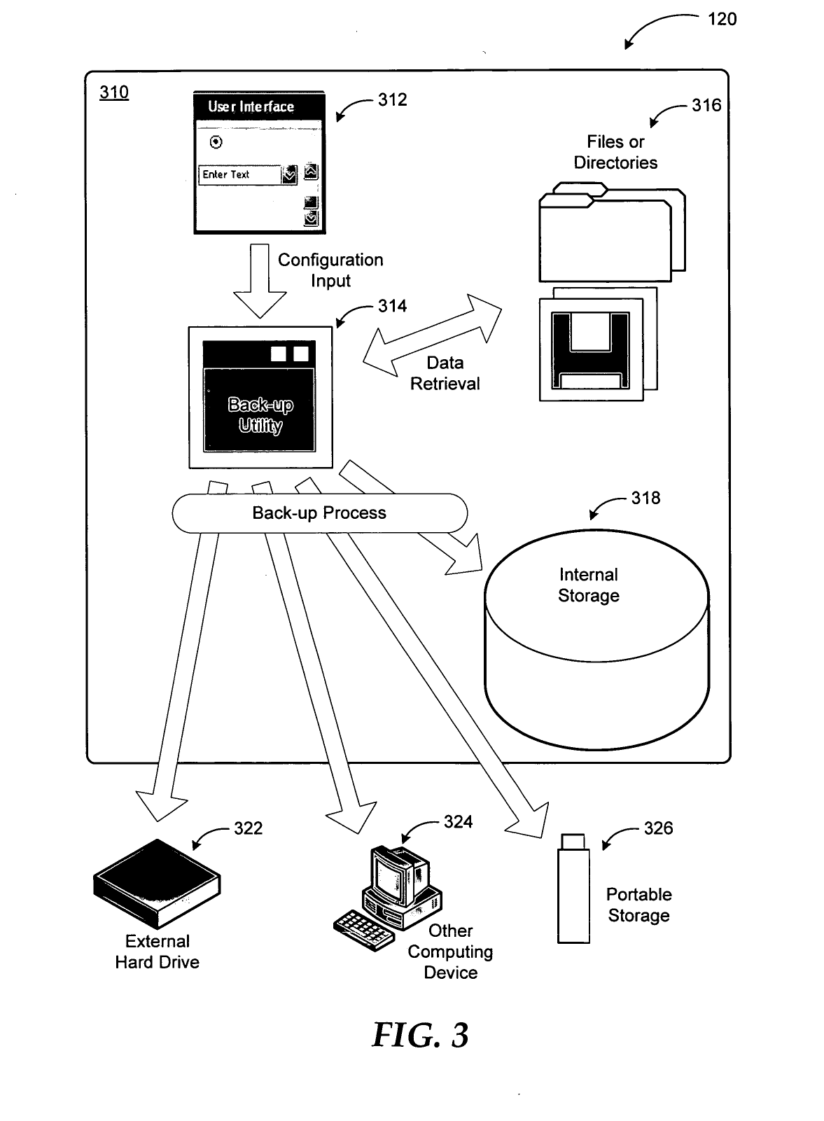

Now referring to FIG. 3, example data back-up utility architecture of back-up application 120 according to embodiments is illustrated. Back-up application 120 may be executed in any topology of processing systems, storage systems, source systems, and configuration systems.

A core of back-up application 120 is back-up utility 314. Back-up utility 314 may be an integral or associated part of a data management application such as back-up application 120. On the other hand, back-up application 120 may perform tasks in addition to those performed by the back-up utility 314. For example, back-up application 120 may also facilitate communication between various servers and clients, offer a calendar service, issue alerts based on back-up status, and the like.

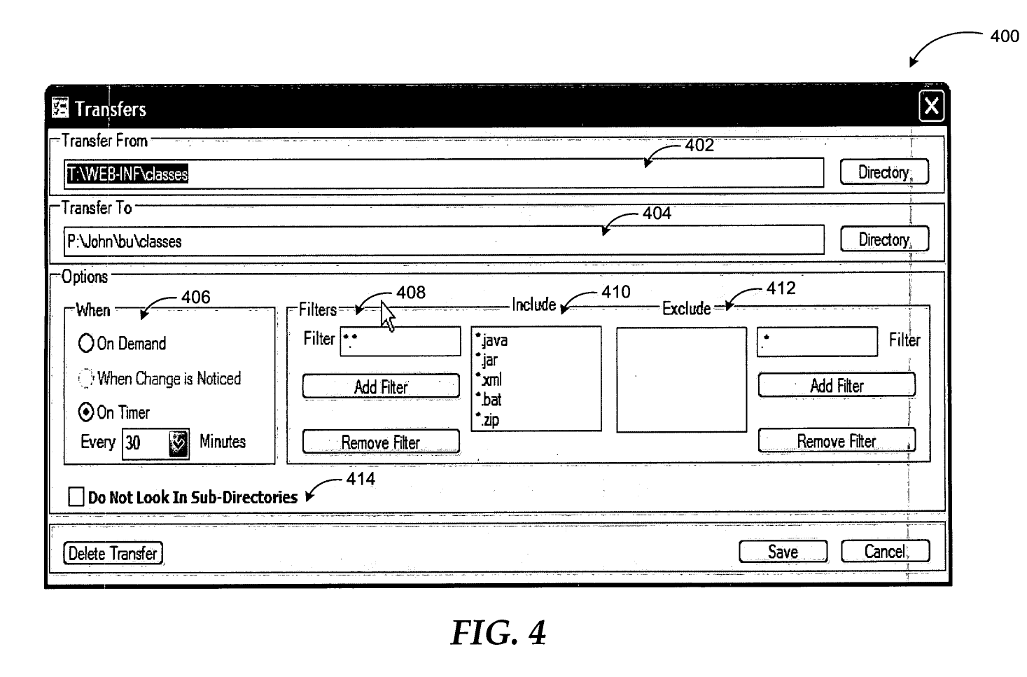

Back-up utility 314 may receive configuration input from user interface(s) 312 for user selectable options of the back-up application 120. Such options may include, but are not limited to, source and destination information for data to be backed-up, a frequency of back-up, any filters to be applied, and the like. User configuration of the back-up application 120 is discussed in further detail below in conjunction with FIG. 4.

Back-up utility 314 may retrieve data to be backed up from files or directories 316. Depending on the user selectable configuration(s), data may be retrieved in files or directories containing files. Data formats to be backed up are not limited to files or, directories, however. Other data types including, but not limited to, data streams (e.g. audio stream), data chunks, and the like may also be backed up by back-up utility 314.

According to one embodiment, back-up utility 314 first determines whether or not a back-up copy of a particular piece of data (e.g. a file) exists in the destination storage. If the back-up copy exists, the back-up utility 314 performs a comparison to determine whether the source file is different from the back-up copy before attempting the back-up. If the back-up copy does not exist, no comparison is necessary. A next step in the operation of back-up application 120 includes the back-up utility 314 determining whether the source file is accessible. A file may not be accessible due to another application currently consuming the file, a network condition, and the like. To prevent an error and preserve system resources, the back-up utility program 314 may abort attempting to copy the source file if it is currently not accessible. The back-up utility 314 may continue backing up other files and check the inaccessible file(s) at predetermined intervals. The steps described above may be implemented in different orders as well.

Once data is retrieved, the back-up utility 314 stores the back-up data in a number of destinations. Storage destinations may include physical or virtual storage facilities such as hard drives, network drives, portable storage devices, other computing devices, CD-ROMs, tapes, and the like. The storage facilities may be internal or external. Internal storage 318 represents any storage medium that is an integral part of a computing device or system (310), which includes back-up utility 314, and the data source. In some embodiments, the data source may be external to system 310.

External storage destinations are represented in FIG. 3 by example devices external hard drive 322, other computing device 324, and portable storage 326. As mentioned above, many other storage media may be used to store the back-up data. The back-up data may be stored in the same format as the original data or it may be reformatted according to other embodiments. For example, data files may be combined or compressed for efficient use of storage resources. Similarly, stored back-up data may be designated the same way as the original data (e.g. file names preserved) or a different designation used for ease of tracking, and the like (e.g. renaming the files using a time stamp associated with the back-up process).

Furthermore, back-up application 120 may implement user credentials and/or permission levels based filtering to determine which files (or directories) can be backed up or which destinations can be used for back up purposes. According to further embodiments, a frequency of back-up may also be based on user credentials and/or permission levels to manage system resources. For example, programmers in an enterprise system may be allowed to back up all files associated with programming, while financial staff may be allowed to back up financial data files only.

In some embodiments, back-up utility 314 may interact with other applications that receive information associated with the back-up application 120 and provide services such as reports, analyses, alerts, and the like. Other applications may include a graphical representation application, a database application, a data analysis application, a communications application, an alerting application, and the like.

FIG. 4 illustrates a screenshot of an example data back-up application configuration UI 400. UI 400 includes path designations 402 and 404 for a user to define the paths for the source and destination of the back-up data, respectively. The paths may include directory paths within a computing device or network system, URLs, and the like.

Portion 406 of UI 400 is an example of user options for defining a frequency of a back-up service. The frequency may be defined as on demand, when change is detected, at preset intervals (user may be given options for the interval), and the like. Other types of frequency definitions may also be implemented using the principles described herein.

Filters 408 may be used to restrict data to be backed up. For example, the user may be prompted to specify or select from a set of file types to include only those selected file types in field 410. Similarly, selected file types may also be specified in field 412 to be excluded from the list of data to be backed up.

In other embodiments, additional filters such as defining whole or partial file names to be included or excluded, defining date ranges for changes to files, defining persons who generated or modified the files, and the like, may be implemented as well.

In a data structure comprising directories and files within the directories, a filter such as the “Do Not Look In Sub-Directories” 414 may be used to limit source paths to top level directories only. In further embodiments, the user may be provided an option to specify a number of directory levels for source data.

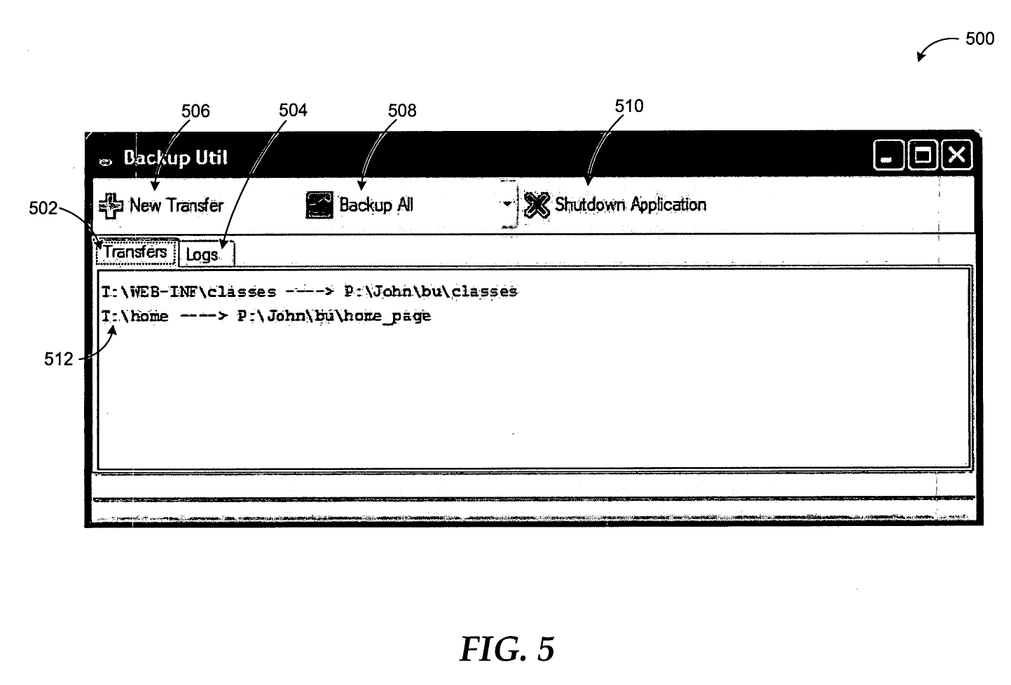

FIG. 5 illustrates a screenshot of an example data back-up application status UI 500 according to embodiments. UI 500 includes a listing (512) of user defined data transfers or back-ups in transfers form 502. A logs form 504 (only the tab is shown in the figure) may present a log of past back-ups an statistics associated with the past back-ups.

According to some embodiments, the user may select a back-up service from the list (e.g. by clicking on the transfer) and be provided with the configuration UI associated with that transfer. A “New Transfer” icon 506 enables the user to start a new back-up process defining or using default values for configuration items discussed above. “Backup All” icon 508 enables the user to initiate a back-up of all data associated with the computing device 100 and/or the user to predefined destination(s). Finally, a “Shutdown Application” icon 510 is provided to terminate the back-up application 120.

A status UI according to embodiments may include additional information such as statistical information associated with the back-up(s), information associated with related applications such as those described in conjunction with FIG. 3, and the like.

While the UIs of FIGS. 4 and 5 are shown with example elements, embodiments are not so limited. Other elements such as additional filters, frequency definitions, and formats of presenting those elements may be implemented using the principles described herein.

Furthermore, the example implementations of back-up application 120, back-up utility 314, and UIs in FIGS. 4 through 6 are intended for illustration purposes only and should not be construed as a limitation on embodiments. Other embodiments may be implemented without departing from a scope and spirit of the invention.

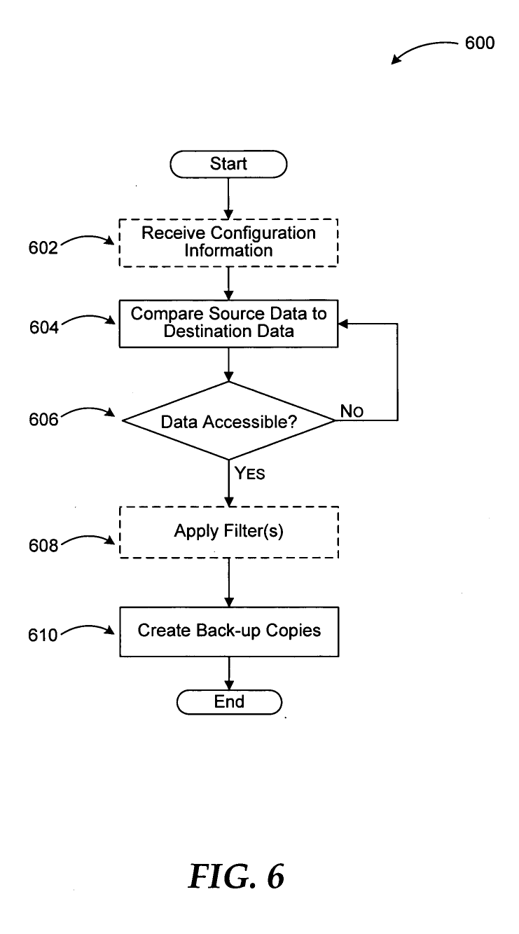

FIG. 6 illustrates a logic flow diagram for a process 600 of backing-up data based on user selectable configuration(s) according to one embodiment. Process 600 may be implemented in a data management application such as a back-up application as described in FIGS. 1 and 2.

Process 600 begins with optional operation 602, where back-up application 120 receives configuration information from a user interface. In some embodiments, the configuration information may be predetermined based on the computing device, user credentials, and the like. Processing moves from optional operation 602 to operation 604.

At operation 604, the back-up application 120 compares the source data to the destination data. If a back-up copy of the source data does not exist at the back-up destination, no further investigation may be necessary. If a back-up copy does exist at the destination, a further comparison may be performed to determine if the source data is different from the back-up copy (e.g. file has been modified). Processing advances from operation 604 to decision operation 606.

At decision operation 606, the back-up application 120 determines whether the data is accessible. As described previously, source data may be temporarily or permanently inaccessible due to being consumed by another application, a source condition, a network condition, and the like. If data is not accessible, processing returns to operation 604. If data is accessible, processing continues to optional operation 608.

At optional operation 608, the back-up application 120 applies one or more filters. A number and an order of filters to be applied may be user defined, based on a default set of rules, or a combination of the two. Processing moves from optional operation 608 to operation 610.

At operation 610, the back-up application 120 creates a back-up copy of the source data (transfer). As described previously, formatting, naming, and other properties of the source data may be modified in conjunction with the back-up application 120. After operation 610, processing moves to a calling process for further actions.

The operations included in process 600 are for illustration purposes. Backing up data based on user selectable configurations may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for backing up data, comprising:
determining a source information and a destination information associated with the data to be backed up;
determining at least one configuration parameter associated with backing-up the data;
if a back-up copy of the data exists at the destination, comparing the data to the back-up copy; and
if the data differs from the back-up copy, creating a new back-up copy at the destination applying the at least one configuration parameter.

2. The method of claim 1, further comprising:
determining whether the data is accessible before attempting to create the new back-up copy; and
if the data is inaccessible, retrying to back up the data after a predetermined period.

3. The method of claim 2, further comprising:
terminating attempts to back up the data after a predetermined number of tries; and
providing an error alert.

4. The method of claim 1, wherein the source information and the destination information include one of: a directory path, a network address, and a URL.

5. The method of claim 1, wherein the destination includes at least one of: a hard drive, a portable storage device, a virtual drive, and a programmable storage medium.

6. The method of claim 1, further comprising:
modifying an attribute of the data when creating the back-up copy.

7. The method of claim 6, wherein the attribute includes at least one of: a naming convention associated with the data and a formatting of the data.

8. The method of claim 1, wherein the at least one configuration parameter includes one of: a frequency of back-up process and a filter.

9. The method of claim 8, wherein the frequency of the back-up process is defined by one of: on demand, when change is detected, and a predetermined interval.

10. The method of claim 8, wherein the filter includes one of an inclusion rule and an exclusion rule based on at least one of: a data type, a data size, a data modification date, a data creation date, and an author associated with the data.

11. The method of claim 1, wherein the at least one configuration parameter is applied based on a user credential.

12. The method of claim 1, wherein the source and the destination are restricted based on a user credential.

13. The method of claim 1, wherein the at least one configuration parameter is determined based on one of a default value and a user selection.

14. The method of claim 1, further comprising:
providing information associated with backing up the data to an application configured to provide at least one of: a report, an analysis, and an alerts.

15. A computer-readable medium having computer executable instructions for backing up data, the instructions comprising:
determining a source path and a destination path associated with the data to be backed up, wherein the data is stored in a file;
determining a frequency and at least one data selection filter associated with backing-up the data;
if a back-up copy of the file exists at the destination, comparing the data in the file to the data in the back-up copy; and
if the data in the file differs from the data in the back-up copy, creating a new back-up copy at the destination applying the at least one filter at the determined frequency.

16. The computer-readable medium of claim 15, wherein the instructions further comprise:
modifying at least one of a format and a name of the file when creating the back-up copy.

17. The computer-readable medium of claim 16, wherein the modified name of the file is configured to indicate at least one of: the source path, a version of the back-up copy, and a time of creating the back-up copy.

18. A system for backing up data, comprising:
a back-up application arranged to:
determine a source path and a destination path associated with a file to be backed up, wherein the file is stored in a directory structure;
determine at least one configuration parameter associated with backing-up the file;
compare the file to a back-up copy, if the back-up copy of the file exists at the destination; and
create a new back-up copy at the destination applying the at least one configuration parameter, if the file differs from the existing back-up copy; and
a configuration user interface (UI) arranged to:
provide default values for the at least one configuration parameter, wherein the at least one configuration parameter includes one of: a frequency of back-up process and a filter; and
prompt a user to one of: selecting from the default values and entering new values.

19. The system of claim 18, wherein the configuration UI is further arranged to determine one of an inclusion rule and an exclusion rule for selecting the file within the directory structure.

20. The system of claim 18, wherein the configuration UI is further arranged to present an option to select a level of directories to be searched for files to be backed up.
